(19) United States
(12) Patent Application Publication
(10) Pub. No.: US 2023/0397573 A1
(43) Pub. Date: Dec. 14, 2023

(54) PET WATER DISPENSER

(71) Applicant: Qingdao Ecopure Filter Co., Ltd., Qingdao (CN)

(72) Inventor: Zhibin Zou, Qingdao (CN)

(73) Assignee: Qingdao Ecopure Filter Co., Ltd., Qingdao (CN)

(21) Appl. No.: 18/333,648

(22) Filed: Jun. 13, 2023

(30) Foreign Application Priority Data
Jun. 13, 2022 (CN) 202221465869.X
Aug. 18, 2022 (CN) 202222174353.6

(51) Int. Cl. A01K 7/02

(52) U.S. Cl. CPC A01K 7/025

(57) ABSTRACT

A pet water dispenser having a water tank assembly, a filter assembly, and a water pumping assembly. The water tank assembly include a tank body defining an interior space for water storage and a top cover detachably arranged on the tank body above the interior space. The top cover having an upper surface defining a drinking tray with a first water return port. The filter assembly is detachably installed in the interior space and located below the first water return port. The water pumping assembly is detachably connected on a side of the tank body and configured to circulate water from the interior space into the drinking tray where the water returns back to the interior space through the water return port and filter assembly.

### TECHNICAL FIELD

This application claims priority to Chinese Patent Application No. 202221465869.X, filed on Jun. 13, 2022, and Chinese Patent Application No. 202222174353.6, filed on Aug. 18, 2022, which are incorporated herein by reference in their entireties.

### TECHNICAL FIELD

This application generally relates to a pet water dispenser and, in particular to a pet water dispenser with water filtering capabilities.

### BACKGROUND

Pet water feeders are used by many pet owners to provide drinking water for their pets. If the water is not changed regularly and/or if the feeder is not cleaned regularly, bacteria and microorganisms can flourish rendering the drinking water unsanitary. For example, mold spores that attach to pets in the outdoor air can fall into drinking trays or water tanks, and breed. The mold can cause health problems in pets, and exposure to mold may cause respiratory and digestive symptoms.

To address potential water quality issue, pet water feeders with filtering functions have appeared on the market. This type of water feeder generally has a filter device fixedly installed in the water tank, and the filter material is a consumable material that needs to be replaced or cleaned regularly to ensure the filtering effect. For example, Chinese patent application (CN217038395U) discloses a pet water dispenser, which includes a base, a cover plate, a water storage tank and a water pump. The base forms a water inlet tank and a drinking water tank respectively, and the water pump is arranged in the drinking water tank of the base. Thus, the water inlet tank, the drinking water tank, the water pump, and the control circuitry are all integrated in the base, which makes cumbersome to clean and service.

### SUMMARY

This summary is meant to provide some examples and is not intended to be limiting of the scope of the invention in any way. For example, any feature included in an example of this summary is not required by the claims, unless the claims explicitly recite the feature. Also, the features, components, steps, concepts, etc. described in examples in this summary and elsewhere in this disclosure can be combined in a variety of ways. Various features and steps as described elsewhere in this disclosure may be included in the examples summarized here.

In some embodiments, a pet water dispenser includes a water tank assembly, a filter assembly, and a water pumping assembly. The water tank assembly includes a tank body defining an interior space for storing water and a top cover detachably arranged on the tank body above the interior space. The top cover has an upper surface that at least partially defines a drinking tray with a first water return port. The filter assembly is detachably installed in the interior space and located below the first water return port. The water pumping assembly is detachably connected on a side of the tank body and is configured to circulate the water from the interior space into the drinking tray where the water can return back into the interior space through the first water return port and the filter assembly.

In some embodiments, the upper surface forms a concave shape having a bottom surface, and wherein the first water return port is positioned higher than the bottom surface. In some embodiments, wherein the first water return port is located on a curved surface. In some embodiments, the tank body is a cuboid shaped. In some embodiments, the water pumping assembly is received in a recessed portion of an outer surface of a sidewall of the tank body.

In some embodiments, the pet water dispenser includes a second water return port located below the filter assembly such that water filtered by the filter assembly returns to the interior space via the second water return port. In some embodiments, the filter assembly includes a filter housing defining a filter cavity configured to house a replaceable filtering element.

In some embodiments, the filter cavity is in fluid communication with the first water return port. In some embodiments, the top cover includes a downward projecting edge the fits over a top edge of the tank body.

In some embodiments, a pet water dispenser includes a water tank assembly, a water pumping assembly, and a base. The water tank assembly includes a tank body defining an inner cavity for water storage and a top cover detachably arranged on the tank body above the inner cavity. The top cover has an upper surface that at least partially defines a drinking tray with a first water return port. The water pumping assembly is detachably arranged on a side of the tank body and configured to circulate the water from the inner cavity into the drinking tray. The base onto which the tank body is detachably arranged. has one or more load cells communicatively connected to the water pumping assembly.

In some embodiments, the pet water dispenser includes a controller configured to receive a signal from the one or more load cells indicative of a water volume in the inner cavity and the drinking tray and to output water volume information to a user interface based on the signal. In some embodiments, the controller is a control chip positioned in the water pumping assembly.

In some embodiments, the water pumping assembly includes a first rechargeable battery and the base includes a second rechargeable battery. In some embodiments, the first rechargeable battery and the second rechargeable battery can be charged independent of each other. In some embodiments, the base includes a plurality of recesses, and the tank body includes a plurality of supporting legs. Each of the plurality of recesses is configured to receive a corresponding one of the plurality of supporting legs.

In some embodiments, a pet water dispenser includes a water tank assembly, a filter assembly or filter element, and a water pumping assembly. The water tank assembly includes a tank body defining an interior space for storing water and a top cover detachably arranged on the tank body above the interior space. The top cover has an upper surface defining a drinking tray with a water return port. The filter assembly or filter element is detachably connected to the top cover. The water pumping assembly is detachably connected on a side of the tank body and configured to transport the water from the interior space to the drinking tray.

In some embodiments, the water pumping assembly includes a housing detachably connected with the tank body, a pump arranged in the housing, a sensor is arranged on the housing and configured to generate a pet detection signal, and a controller arranged in the housing. The controller is communicatively connected with the sensor and the pump. In some embodiments, the controller is configured to receive the pet detection signal from the sensor and, based on the pet detection signal, control the pump to send the water to the drinking tray or stop sending the water to the drinking tray.

In some embodiments, the pump includes a water inlet connected to a water supply conduit that extends into the interior space and a water outlet connected to a water outlet conduit configured to deposit the water into the drinking tray. In some embodiments, the water outlet conduit is L-shaped and includes a horizontal pipe section configured to position a water outlet port of the water outlet conduit at a surface of the water in the drinking tray. In some embodiments, the water return port is located at an opposite side of the drinking tray from the water pumping assembly. In some embodiments, the water return port is at least partially lower than the water outlet of the water outlet conduit.

In some embodiments, the pet water dispenser includes a filter element connector that detachably connects the filter element to the drinking tray. The filter element connector can be positioned below the water return port.

In some embodiments, the water pumping assembly includes an ultraviolet lamp positioned within the interior space. The ultraviolet lamp having an incident end surface provided with lamp beads wherein the incident end surface is arranged obliquely towards the interior space.

In some embodiments, a water dispenser includes a water tank having an inner cavity for storing water, a top cover arranged on the top of the water tank, and an assembly opening is opened on the top cover. A filter assembly is detachably fitted in the assembly opening. In some embodiments, when the filter assembly is assembled into the top cover, the top surface of the filter assembly is combined with the top cover to form a drinking tray for drinking water. In some embodiments, the drinking tray is in a concave shape with a low inner surface and a higher outer surface.

In some embodiments, the filter assembly includes a filter housing and a filter cavity formed inside the filter housing. The top of the filter housing is open and the filter cavity is filled with a filter material. In some embodiments, the filter material includes resin and/or activated carbon. In some embodiments, a water outlet is opened at the bottom of the filter housing.

In some embodiments, a filter housing cover is assembled on the top opening of the filter housing. When the filter assembly is assembled in the assembly opening, the filter housing cover and the top cover form a drinking tray. In some embodiments, the filter housing cover includes a water inlet.

In some embodiments, the lower surface of the filter housing cover extends downward to form guide ribs that match the inner wall of the filter cavity. The guide ribs are inserted into the filter cavity to connect with the filter cavity such that the filter housing cover is detachably connected to the filter housing.

In some embodiments, the side of the water tank close to the outer edge of the assembly opening has a clamping edge, and the end of the filter housing cover close to the outer edge of the assembly opening is folded down to form a locking edge which is received over and engages the clamping edge when the filter assembly is assembled in the opening. In some embodiments, a shoulder is formed on the inner side of the assembly opening along a circumference of the assembly opening. An outer retaining ring is formed on the outer periphery of the filter housing. When the filter housing is received into the assembly opening, the outer retaining ring is supported on the shoulder.

In some embodiments, a guide groove is formed on the outer wall of the filter housing, and a guide structure matching the guide groove is formed on the side wall of the assembly opening. In some embodiments, when the filter assembly is assembled in the assembly opening, the filter housing cover forms a seal with the assembly opening.

In some embodiments, the pet water dispenser includes a water pumping assembly, which is used to pump and discharge the water in the water tank to the top cover. In some embodiments, the water on the top cover enters the filter assembly through the water inlet to be filtered and then circulates into the water tank from the water outlet.

In some embodiments, a water dispenser for pets includes a water tank. An interior space or cavity for storing drinking water is formed inside the water tank. In some embodiments, the bottom surface of the interior space is in an arc shape protruding downward and is inclined from high to low from the end far away from the communication port. In some embodiments, a water pumping assembly is detachably connected to one side of the water storage tank. In some embodiments, the water pumping assembly includes a water outlet conduit having a water outlet located in the drinking water tray above the cavity, a water inlet conduit extending through a communication port formed on the drinking tray protrudes and into the cavity, and a water pump. The water inlet end of the water pump communicates with the water inlet conduit and the water outlet end of the water pump communicates with the water outlet conduit. In some embodiments, in order to prevent water from accumulating, the bottom surface of the cavity is in an arc shape protruding downward and is inclined from high to low from the end far away from the communication port.

In some embodiments, the pet water dispenser includes a base arranged under the water tank and one or more load cells are arranged in the base to detect the amount of water in the pet water dispenser. In some embodiments, the water pumping assembly is detachably fixedly connected to the base.

In some embodiments, the water storage tank and the water pumping assembly of the pet water dispenser can be quickly connected. In some embodiments, the water storage tank has a first connection part and the second connecting part. In some embodiments, the first connection part is formed on the water storage tank part and is recessed toward the communication port on the side wall and the second connecting part is located at the bottom end of the side wall. In some embodiments, a plurality of second connecting parts are symmetrically arranged in groups.

In some embodiments, the water pumping assembly includes a housing having a first mounting slot and a second mounting slot. In some embodiments, the first mounting slot extends in the same direction as the second mounting slot. When the water pumping assembly is attached to the water storage tank, the first connecting part extends into the first mounting slot and the second connecting part extends into the second mounting slot.

In some embodiments, the pet water dispenser includes an inductive sensor to generate a pet detection signal. In some embodiments, the inductive sensor disposed on the housing of the water pumping assembly. In some embodiments, the pet water dispenser includes a controller that receives the pet detection signal generated by the inductive sensor and generates a driving signal to drive the water pump to work.

In some embodiments, the pet water dispenser can detect the water volume in the pet water dispenser through one or more load cells. In some embodiments, one of the water pumping assembly and the base is provided with a terminal and the other is provided with an interface. The interface and the terminal form a communication connection such that the controller receives a weighing detection signal generated by the load cell.

In some embodiments, the water pumping assembly and the base can independently charge and discharge. In some embodiments, the water pumping assembly includes a first battery and the base includes a second battery. The first and second batteries can be independently charged from each other. In some embodiments, the second battery can supply power to the water pumping assembly and the base at the same time.

In some embodiments, the noise of the water flow is reduced by the water pumping assembly design. In some embodiments, water outlet conduit is L-shaped and includes a horizontal pipe section extending in the same direction as the drinking tray. The water outlet of the water outlet conduit is set at the horizontal pipe section which is configured to be at, or near, the water level in the drinking tray.

In some embodiments, the drinking tray is configured to return water to the water tank, prevent water overflow, and filter the water at the same time. In some embodiments, drinking tray includes a water return port that is at least partly lower than the water outlet of the water outlet conduit. In some embodiments, the filter connection part is used to connect the filter assembly or element detachably and fixedly to the drinking tray and is located below the water return port. In some embodiments, the drinking tray includes a first overflow opening on the end wall of the filter connecting portion and a second overflow opening on the end wall surrounding the communication opening.

In some embodiments, the pet water dispenser has a sterilizing function. In some embodiments, the water pumping assembly includes an ultraviolet lamp. The ultraviolet lamp can extend through the communication port formed on the drinking tray into the interior space. In some embodiments, the ultraviolet lamp has at least one incident end surface provided with lamp bulbs or beads and the incident end surface is inclined towards the interior space.

In some embodiments, in order to facilitate access and prevent overturning, the base is provided with a plurality of recesses, and a plurality of legs are arranged under the water tank assembly that are received in the recesses when the water tank assembly is mounted on the base.

### DESCRIPTION OF DRAWINGS

To further clarify various aspects of implementations of the present disclosure, a more particular description of the certain examples and implementations will be made by reference to various aspects of the appended drawings. These drawings depict only example implementations of the present disclosure and are therefore not to be considered limiting of the scope of the disclosure. Moreover, while the FIGS. can be drawn to scale for some examples, the FIGS. are not necessarily drawn to scale for all examples. Examples and other features and advantages of the present disclosure will be described and explained with additional specificity and detail through the use of the accompanying drawings in which:

FIG. 1 is the structural representation of an example pet water dispenser;

FIG. 2 is an exploded view of the pet water dispenser of FIG. 1;

FIG. 3 is a sectional view of FIG. 2;

FIG. 4 is a perspective view of an example pet water dispenser;

FIG. 5 is the front view of the pet water dispenser of FIG. 4;

FIG. 6 is a sectional view of the pet water dispenser of FIG. 5 taken along the A-A line;

FIG. 7 is a partial exploded view of the pet water dispenser of FIG. 4;

FIG. 8 is a side view of an example dispensing assembly for the pet water dispenser of FIG. 4;

FIG. 9 is an exploded view of the dispensing assembly of FIG. 8;

FIG. 10 is perspective view of a water storage tank and a drinking tray of the pet water dispenser of FIG. 4;

FIG. 11 is perspective view of a drinking tray and a filter element of the pet water dispenser of FIG. 4;

FIG. 12 is a partial exploded view of a drinking tray, a filter element, and a water storage tank of the pet water dispenser of FIG. 4;

FIG. 13 is a side view of a base of the pet water dispenser of FIG. 4;

FIG. 14 is a bottom view of the base of the pet water dispenser of FIG. 4;

FIG. 15 is an exploded view of the base of the pet water dispenser of FIG. 4;

FIG. 16 is partial assembled view of the pet water dispenser of FIG. 4;

FIG. 17 is rear partial assembled view of the pet water dispenser of FIG. 4;

FIG. 18 is bottom partial assembled view of the pet water dispenser of FIG. 4;

FIG. 19 is a cross-sectional view along the length direction of the water storage tank of the pet water dispenser of FIG. 4; and

FIG. 20 is a cross-sectional view along the width direction of the water storage tank of the pet water dispenser of FIG. 4.

### DETAILED DESCRIPTION

The following description refers to the accompanying drawings, which illustrate example implementations of the present disclosure. Other implementations having different structures and operation do not depart from the scope of the present disclosure.

It should be noted that, in the description of the present application, terms such as “up”, “down”, “left”, “right”, “vertical”, “horizontal”, “inside,” and “outside” indicate directions or are terms of positional relationship that are based on the direction or positional relationship shown in the drawings, which are only for convenience of description, and do not indicate or imply that the device or element must have a specific orientation, be constructed and operated in a specific orientation, and therefore cannot be understood. In addition, the terms “first” and “second” are used for descriptive purposes only and should not be understood as indicating or implying relative importance. Furthermore, the term “plurality” means two or more, unless otherwise specifically defined.

In the present application, unless otherwise specified and limited, terms such as “installation”, “connection”, and “fixation” should be understood in a broad sense. For example, it can be a fixed connection, a detachable connection, an integration, a mechanical connection, an electrical connection, a direct connection or indirect connection through an intermediary, and an internal communication of two components or the interaction relationship between two components. Those of ordinary skill in the art can understand the specific meanings of the above terms in the present application according to specific situations.

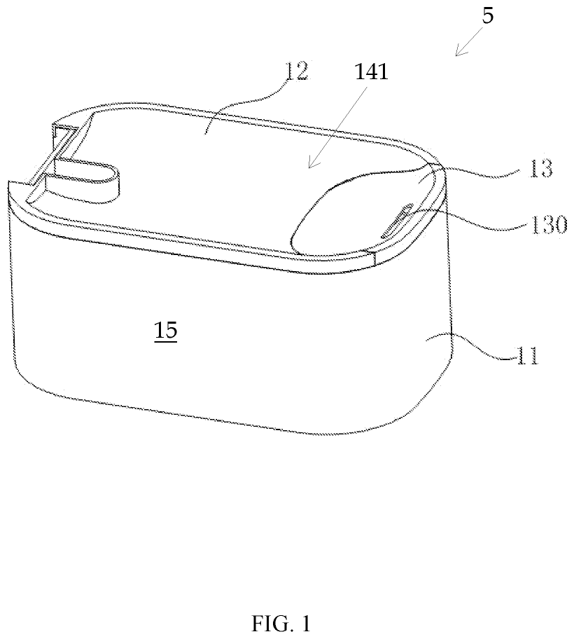

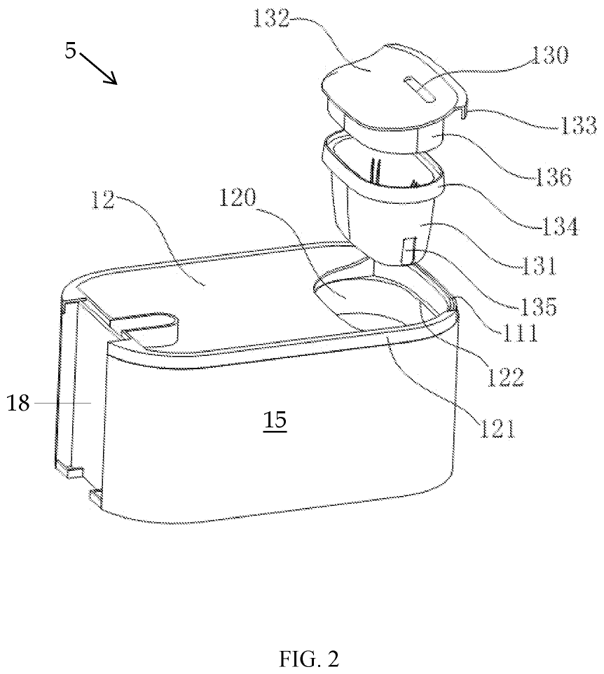

Referring to FIGS. 1-2, an embodiment of a pet water dispenser 5 is disclosed. In some embodiments, the pet water dispenser 5 is configured for providing drinking water for pets. The pet water dispenser 5 can be configured in a variety of ways. In the illustrated embodiment, the pet water dispenser 5 includes a water tank assembly 11, a top cover 12, and a filter assembly 13.

The water tank assembly 11 can be configured in a variety of ways. In the illustrated example, the water tank assembly 11 has a tank body 14 having a plurality of sidewalls 15 and a bottom wall 16 defining an interior space 17 (e.g., cavity, chamber, etc.) for storing water. In the illustrated example, the tank body 14 is configured in a substantially cuboid shape. In other embodiments, however, the tank body 14 can be configured in any suitable shape, such as cube shape, rounded, or other shapes. In some embodiments, the volume of the interior space 17 can roughly meet the drinking water volume needed for small pets (such as cats, dogs, etc.) for 24 hours to 72 hours. In other implementations, the volume of the interior space 17 can any suitable volume according to usage requirements. In some embodiments, the tank body 14 can be made of a transparent material, which facilitates observation of the water volume in the interior space 17 and timely replenishment of water when needed.

The top cover 12 is detachably arranged above the interior space 17. The top cover 12 is arranged to cover an upper opening of the interior space 17 to prevent foreign matter from entering the interior space 17. In some embodiments, the top cover 12 includes an opening 120 for receiving the filter assembly 13. The filter assembly 13 can be detachably assembled in the opening 120.

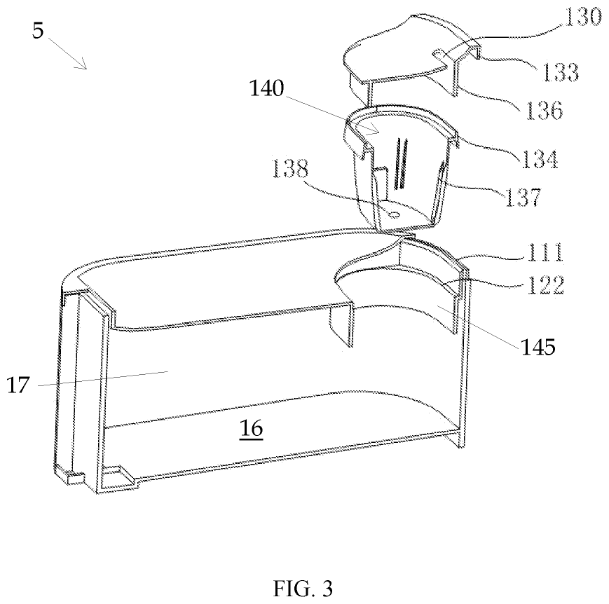

The filter assembly 13 can be configured in a variety of ways. In some embodiments, as shown in FIGS. 2-3, the filter assembly 13 includes a filter housing 131 and a filter housing cover 132. The filter housing 131 defines a filter cavity 140 into which a filter or filter material can be arranged. Any suitable water filter or water filtration material can be used. In some embodiments, the filter material can be, but not limited to, a resin and activated carbon. In some embodiments, the filter material is consumable and the filter assembly 13 is configured to allow the filter material to be replaced regularly.

In the illustrated implementation, the top of the filter housing 131 is open and the filter housing cover 132 is assembled on top of the filter housing 131 to cover the open top end. The filter housing cover 132 can be detachably or moveably connected to the filter housing 131, or it can be fixedly connected. The filter housing cover 132 can be detachably connected or movably connected in any suitable way, such as but not limited to, a snap fit, a threaded connection, a hinged connection, an interference fit, a detent, etc. The filter housing cover 132 and the filter housing 131 can be fixedly connected in any suitable way, such as but not limited to, ultrasonic welding, integral injection molding connection, adhesives, etc.

In the illustrated embodiment, the lower surface of the filter housing cover 132 extends downwards to form a guide rib 136 that matches the shape of the inner wall surface of the filter housing 131 which defines the filter cavity 140. When the filter housing cover 132 is assembled with the filter housing 131, the guide rib 136 is inserted into the filter cavity 140 to pluggably connect (e.g., snug fit, tight fit, interference fit) with the filter housing 131, which facilitates the assembly of the filter assembly 13 and increases the strength of the filter housing cover 132.

In some embodiments, the side of the tank body 11 proximate to an outer edge of the opening 120 has a clamping edge 111 and the end of the filter housing cover 132 proximate to the outer edge of the opening 120 is folded down to form a locking edge 133. The locking edge 133 is received over and engages the clamping edge 111 when the filter assembly 13 is assembled in the opening 120. Thus, the upper edge (i.e., clamping edge 111) of the tank body 11 is not directly exposed the filter assembly 13 is assembled in the opening 120 so as to protect upper edge of the tank body 11 from being damaged, touched, and accumulating dirt. At the same time, the locking edge 133 can be connected with the water retaining strip 121 to improve the smoothness of the surface shape of the water dispenser and enhance the aesthetic feeling.

In some embodiments, the outer diameter of guide rib 136 is preferably smaller than the outer diameter of filter housing cover 132, so that the outer edge of filter housing cover 132 extends outwards and protrudes from guide rib 136. In some embodiments, an upward facing shoulder 122 is formed around an inner surface of the opening 120. A corresponding outer retaining ring or flange 134 is formed on the outer periphery of the filter housing 131. When the filter housing 131 is received in the opening 120, the outer retaining ring 134 engages and is supported on the upward facing shoulder 122 to help support the filter housing 131 help ensure that the height of the filter assembly 13 when installed is not too high or too low so that the transition between the filter housing cover 132 and the top cover 12 is smooth.

In some embodiments, a guide groove 135 is formed on the outer wall of the filter housing 131 and a corresponding guide structure (tab, ridge, button, projection, etc.) (not shown) matching the guide groove 135 is formed on the side wall 145 (FIG. 3) of the opening 120. The guide groove 135 and corresponding guide structure are used for positioning and guiding the filter housing 131 when the filter assembly 13 is assembled in the opening 120. In some embodiments, one or more reinforcing elements 137 (e.g., ribs, strips, projections) are formed on the inner surface of the filter housing 131. In the illustrated example, the inner sidewall surface of the filter housing 131 includes a plurality of reinforcing ribs 137 extending along a vertical direction to increase the strength of the filter housing 131 and prevent deformation during long-term use.

When the filter assembly 13 is assembled in the opening 120, the filter housing cover 132 and the top cover 12 form a complete top surface structure that defines a drinking tray 141. In other words, the upper surface of the filter housing cover 132 transitions smoothly (i.e., aligned) with the top surface of the top cover 12. In some embodiments, the drinking tray has a concave shape with a recessed lower inner portion or surface and a higher outer portion. In some embodiments, the upper surface of the filter housing cover 132 is a curved surface that smoothly blends with the concave surface of the top cover 12 to form the drinking tray 141.

The upper surface of the drinking tray 141 has a certain water storage capacity such that pets can drink from the water in the drinking tray 141. Excess water from the drinking tray 141 can be filtered by the filter assembly 13 and returned to the interior space 17. As shown in FIG. 3, in some embodiments, the filter assembly 13 includes a first water return port or water inlet 130 formed in the filter housing cover 132 and a second water return port or water outlet 138. Both the first water return port 138 and the second water return port 138 communicate with the filter cavity 140.

When the filter assembly 13 is assembled in the opening 120, the top of the filter assembly 13 abuts against at top edge of the opening 120. Surplus water in the drinking tray 141 can enter the filter assembly 13 through the first water return port 130 and flow into the filter cavity 140 where the water is filtered by the filter or filtering material. Once filtered, the water can return to the interior space 17 through the second water return port 138. In some embodiments, the second water return port 138 is positioned at the bottom of the filter housing 131, which can prolong the path of the water in filter cavity 140 so that it can be fully filtered through the filter material.

When the filter assembly 13 is assembled in the opening 120, the top of the filter assembly 13 can be connected with the opening 120 in a sealed or non-sealed fit. For example, the top of the filter assembly 13 can sealing engage with the top cover 12 such that the top cover 12 and the filter housing cover 132 completely close the top of the tank body 14. However, if the top of the filter assembly 13 is non-sealably connected to the opening 120, excess water on the drinking tray 141 will flow into the filter assembly 13 from any gap between the filter assembly 13 and the opening 120 such that filtering effect can still be achieved. The upper edge of the top cover 12 can protrude upward to form a water retaining strip or edge 121 to prevent water in the drinking tray 141 from overflowing other than through the first return port 130.

In some embodiments, the filter assembly 13 can be detached and removed from the opening 120. For example, the filter assembly 13 can be removed to be replaced, to have the filter material in the filter housing 131 replaced, and/or to clean the filter assembly 13. In addition, when the filter assembly 13 is removed from the opening 120, a user can access the interior space 17 via the opening 120 to clean the inner surface of the walls 15, 16 of the tank body 11 and/or can replenish clean water into the interior space 17.

In some embodiments, the pet water dispenser 5 can includes a water pumping assembly (not shown) which is used to pump water from the interior space 17 of the tank body 11 to the drinking tray 141. In some embodiments, the water pumping assembly (not shown) includes a water pump (not shown) and a water inlet conduit (e.g., pipe, tube, passage, etc.) (not shown). Any suitable water pump may be used. One end of the water inlet conduit can extend into the interior space 17 of the tank body 11 to engage water in the interior space 17 and the other end of the water inlet conduit can be operatively connected to the water pump. In some embodiments, the water pump directly discharges the extracted water to the drinking tray 141. A water outlet conduit (e.g., faucet, pipe, tube, passage, etc.) discharges the water onto the drinking tray.

The water pump can be wired, connected to a mains socket through a power cord, and/or powered by a battery (e.g., lithium battery, rechargeable battery, etc.). In some embodiments, the working mode of the water pump is continuous, so that the water flow keeps circulating. In other implementations, the working mode of the water pump is timed such that the pump turns on periodically to provide drinking water to the drinking tray 141.

In the illustrated example, the drinking tray 141 holds a suitable amount of water for pets to drink. Any water exceeding the storage capacity of the drinking tray 141 will enter the filter assembly 13 from the first water return port 130 and return to the interior space 17 in the tank body 11 after being filtered by the filter assembly 13. Thus, the pet water dispenser 5 addresses the problem that the capacity of a conventional pet water bowl is small and needs water added frequently. In addition, excess water in the drinking tray can be filtered by the filter assembly 13 and then returned to the interior space 17, which solves the problem of large-capacity water storage and unsanitary drinking water for pets.

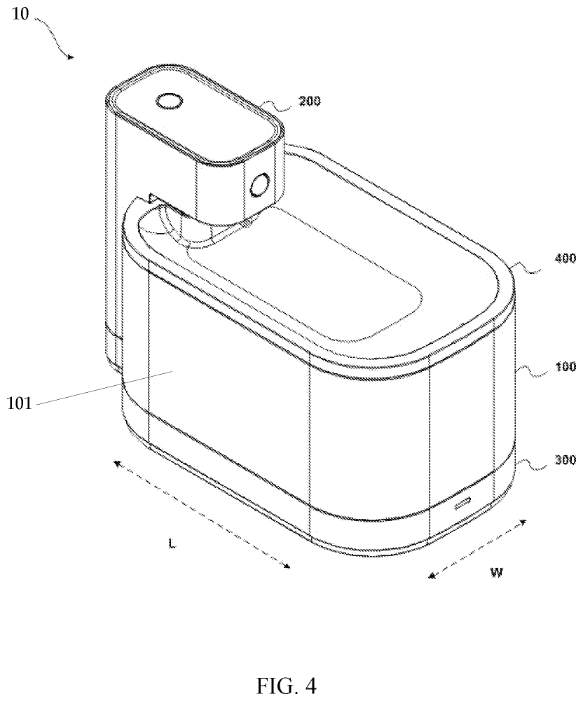

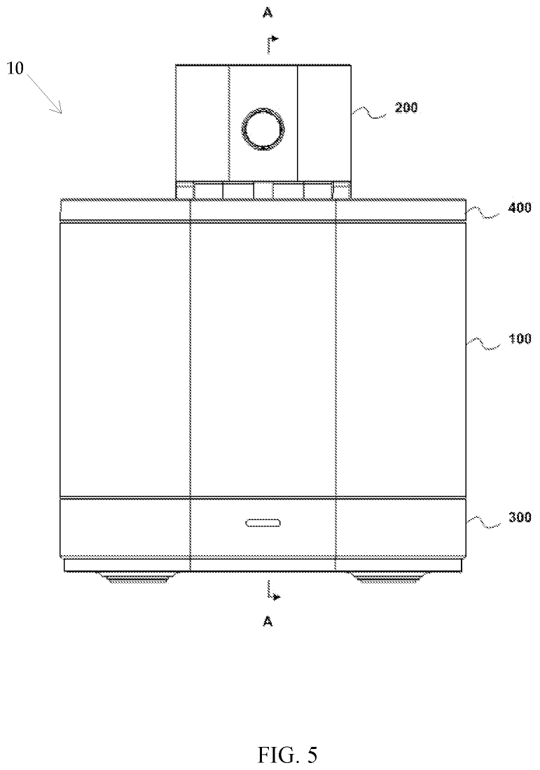

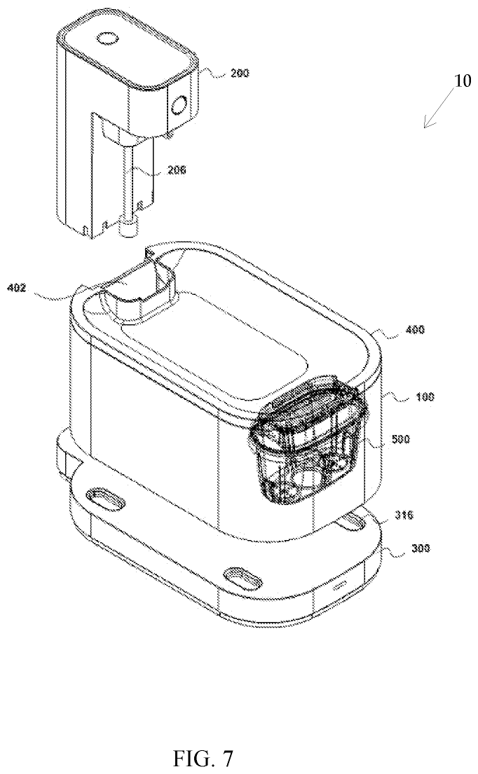

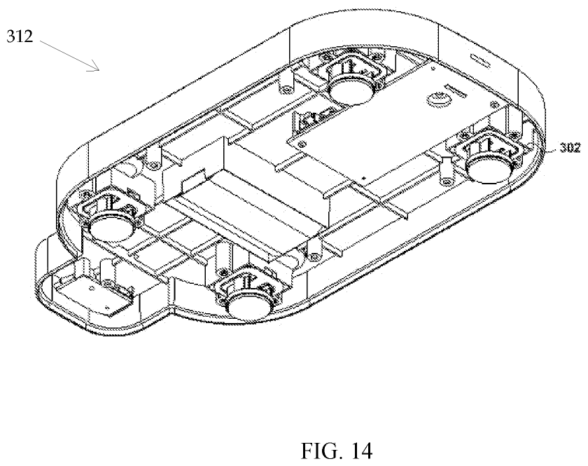

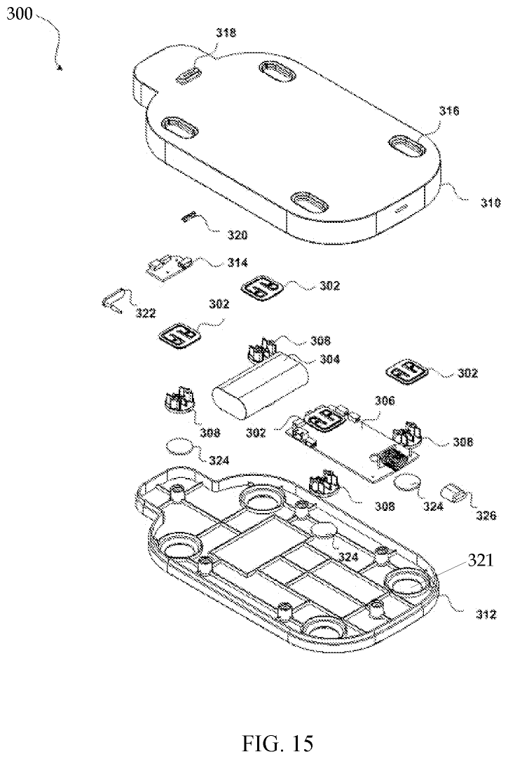

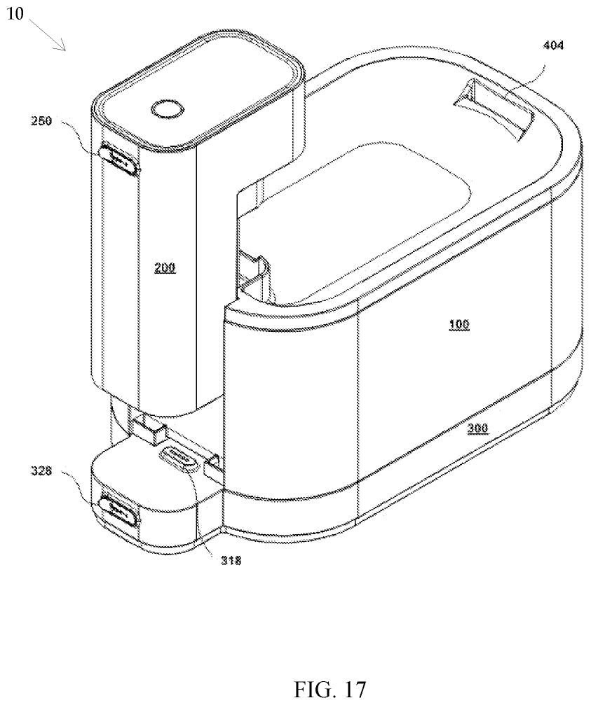

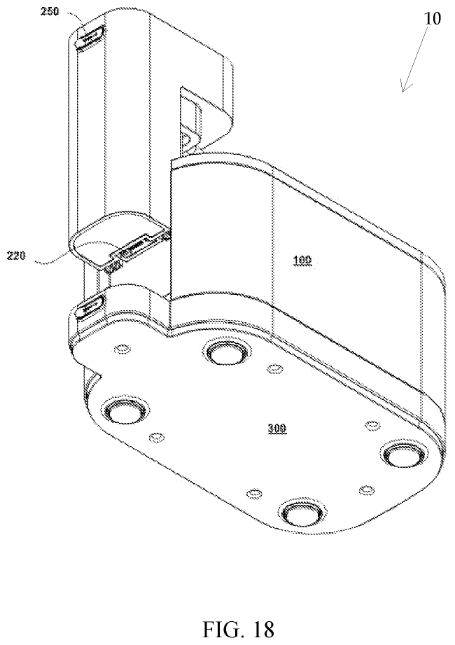

FIGS. 4-20 illustrate an embodiment of a pet water dispenser 10. Referring to FIG. 4, the pet water dispenser 10 includes a water tank assembly 100, a water pumping assembly 200, a base 300, and a filter assembly or element 500 (FIG. 7). The water tank assembly 100 can be configured in a variety of ways. In the illustrated embodiment, the water tank assembly 100 includes a tank body 101 and a drinking tray 400.

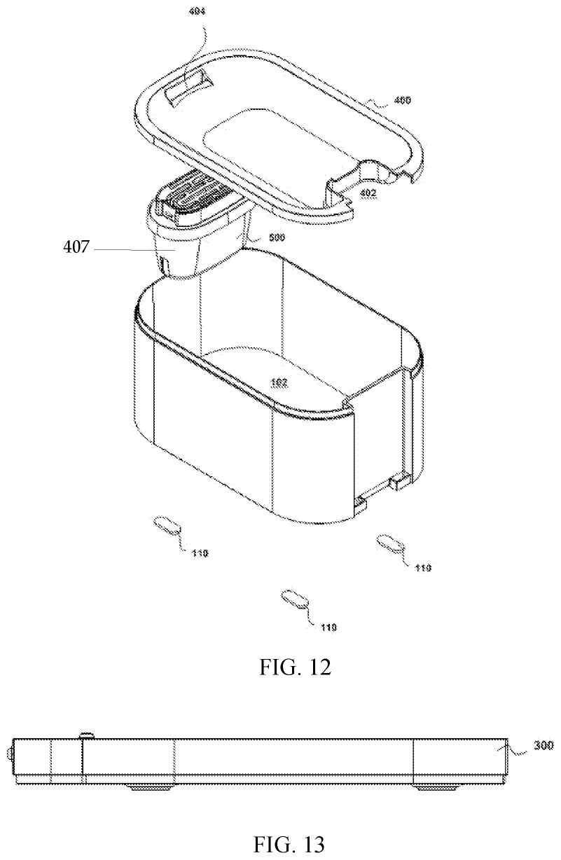

In some embodiments, the tank body 101 is configured in a substantially cuboid shape. In other implementations, however, the tank body 101 can be any suitable shape, such as a cube shape, oval shape, etc. An interior space 102 (e.g., cavity, chamber, etc.) for storing pet drinking water is formed inside the tank body 101. In a preferred embodiment, the volume of the tank body 101 can roughly meet the drinking water volume of small pets (such as cats, dogs, etc.) for 24 hours to 72 hours. The volume of the tank body 101 can also be designed as other volumes according to usage requirements. As shown in FIG. 12, the interior space 102 can be open at the top. The drinking tray 400 is detachably arranged above the t interior space 102, and the drinking tray 400 can cover the open top of the interior space 102 to prevent foreign matter from entering the interior space 102.

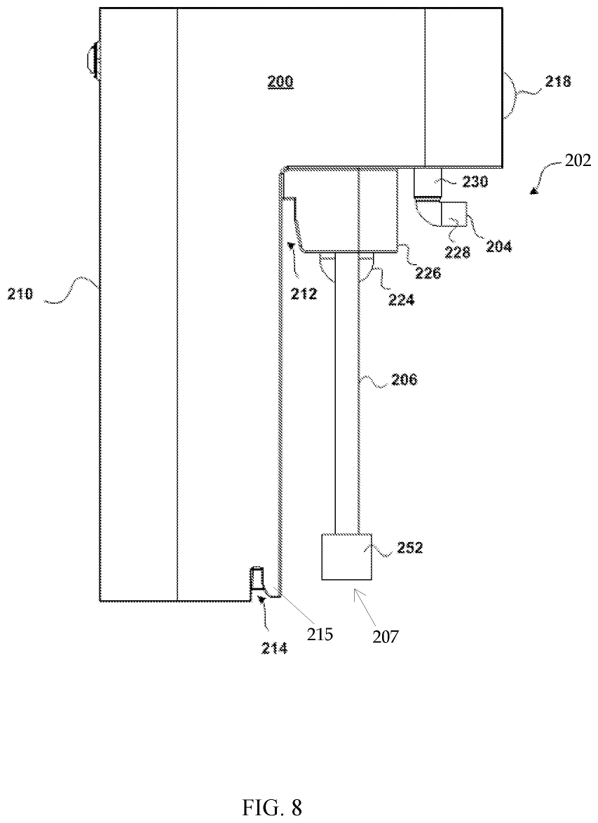

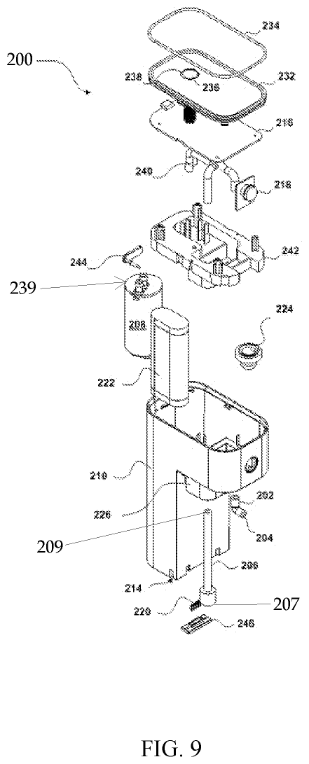

In some embodiments, the water pumping assembly 200 is detachably attached on one side of the tank body 101. Referring to FIGS. 8-9, the water pumping assembly 200 can include a water inlet conduit 206 (e.g., pipe, tube, passage, etc.), a water pump 208, and a water outlet conduit 202 (e.g., pipe, tube, passage, etc.). The water inlet conduit 206 extends into the interior space 102 through a communication port 402 (FIG. 7) formed on the drinking tray 400. The water inlet conduit 206 includes a water inlet port 207 and a water outlet port 209. In some embodiments, the water inlet port 207 is positioned at or near a bottom wall 116 in the interior space 102 of the tank body 101. The water outlet conduit 202 includes a water inlet port and a water outlet port 204. In some embodiments, the water outlet port 204 of the water outlet conduit 202 is positioned in the drinking tray 400 above the interior space 102.

The water pump 208 can be any suitable water pump. In the illustrated implementation, the water inlet conduit 206 is connected to a water inlet end of the water pump 208 and the water outlet conduit 202 is connected to the water outlet end of the water pump 208. The water pump 208 is used to deliver drinking water accumulated in the interior space 102 to the drinking water tray 400 through the water inlet conduit 206 and the water outlet conduit 202.

As shown in FIG. 4, a base 300 is provided below the tank body 100. One or more load cells 302 can be disposed in the base 300, as shown in FIG. 12. The one or more load cells 302 are used to detect the remaining water volume of the pet water dispenser 10 in real time. In some embodiments, the water pumping assembly 200 can be detachably connected to the base 300. The load cells 302 can detect the remaining water in the device, accurately record the amount of drinking water, and output the drinking water data.

In some embodiments, the water tank assembly 100, the water pumping assembly 200, the base 300, and the drinking tray 400 are independent of each other and are fixedly connected to each other in a detachable manner. Thus, each component can be independently cleaned to ensure clean drinking water for pets. In some embodiments, no electrical components are installed in the water tank assembly 100 and the drinking tray 400, which effectively avoids damage to electrical components during the cleaning and drying process and prolongs the service life of the product.

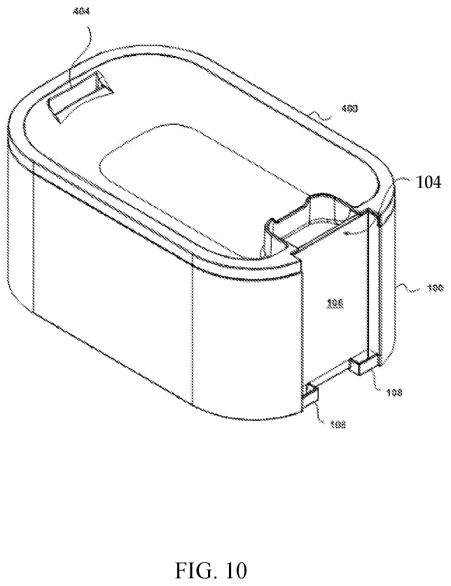

Referring to FIGS. 4-10, the water tank assembly 100, in the length direction (shown by the arrow L in FIG. 1), has the end away from the communication port 402 of the drinking tray 400 that adopts an overall simple, smooth, aesthetically pleasing appearance, which is relatively close to the side of the pet when in use. On the end of the tank body 101 close to the communication port 402 of the drinking tray 400, a side wall 106 (FIG. 10) of the tank body 101 is partially recessed toward the communication port 402 and an upper edge of the recessed side wall 106 forms a first connection portion 104 for the water pumping assembly 200.

In some embodiments, one or more second connecting portions 108 are provided to connect the water pumping assembly 200 to the tank body 101. In the illustrated embodiment, a pair of second connecting portions 108 are symmetrically provided at the bottom end corners of the recessed sidewall 106. The second connecting portions can be configured in a variety of ways. In the illustrated embodiment, the second connecting portion 108 are vertical channels formed by L-shaped connecting end plates and the recessed side wall 106.

In some embodiments, the water pumping assembly 200 the water pump 208 is installed in a housing 210. As shown in FIGS. 7-9, the housing 210 has an L-shaped main body and an extension portion 226 fitted configured to be received in the communication port 402. The water inlet conduit 206 vertically extends downward from the extension portion 226.

The water pumping assembly 200 can detachably connect to the tank body 101 is a variety of ways. In the illustrated embodiment, the water pumping assembly 200 attaches to the tank body 101 at two positions. The housing 210 is provided with one or more first mounting slots 212 and one or more second mounting slots 214. In the illustrated embodiment, the one or more first mounting slots 212 extend in the same direction (e.g., vertically) as the one or more second mounting slots 214. As shown in FIG. 8, one or more first mounting slots 212 is formed between the main body of the housing 210 and the extension portion 226. In the illustrated example, a single first mounting slot 212 is provided. The first mounting slot 212 is closed at the top end and open at the bottom end of the slot. In the illustrated embodiment, the one or more second mounting slots 214 are a plurality of second mounting slots 214 arranged symmetrically in groups at two at the bottom corners of the housing 210 to form a corner projection 215 therebetween. Each of the second mounting slots 214 is closed at the top end and open at the bottom end of the slot.

To attach the water pumping assembly 200 to the tank body 101, the first connecting part 104 is received into the first mounting slot 212 (i.e., the upper end of the recessed side wall 106 extends between the main body of the housing 210 and the extension part 226). In addition, the two second connecting parts 108 are received into the second mounting slots 214 (i.e., the L-shaped connecting end plate extends into the second mounting slots 214, and the corner projection 215 extends into the second connecting parts 108). The above-described mounting structure allows the user attach and detach the water pumping assembly 200 while the connection positions are roughly distributed in a triangle, which has better connection stability.

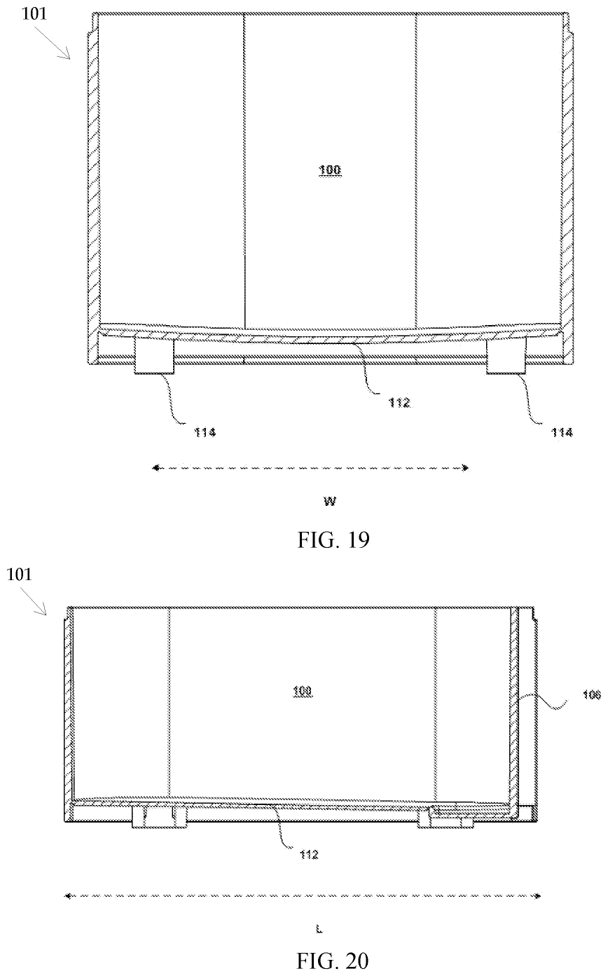

Referring to FIGS. 19-20, in some embodiments, a bottom surface 112 of the interior space 102 formed in the tank body 101 has a downwardly protruding arc shape in the width direction (as shown by the arrow W in the FIG. 19)(i.e., the middle is lower than the two ends). In some embodiments, the bottom surface, from the end far away from the communication port 402, is inclined from high to low (i.e., the water depth at the end of the interior space 102 close to the communication port 402 is deepest). In some embodiments, the water inlet port 207 of the water inlet conduit 206 is located at the bottom surface 112 of the interior space 102 where the water is deepest. Thus, the water pump 208 can fully transport the water in the interior space 102, and the drinking water in the interior space 102 can be fully utilized, avoiding water waste. In some embodiments, the inclination angle of the bottom surface 112 of the interior space 102 is less than 10°.

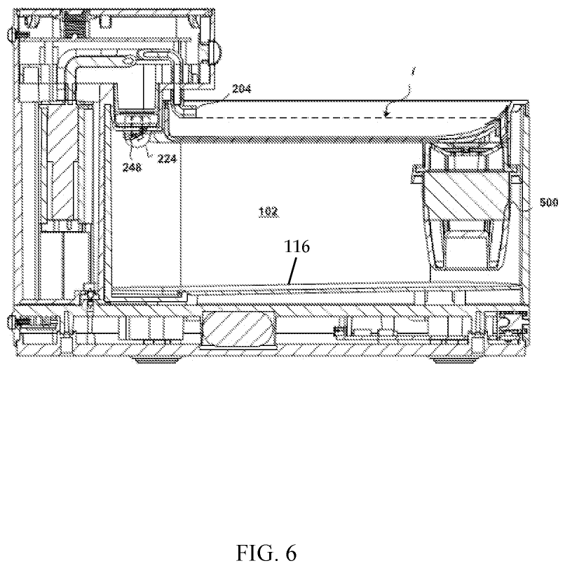

Referring to FIG. 6 and FIG. 8, in some embodiments, the water outlet conduit 202 is L-shaped and includes a vertical pipe section 230 and a horizontal pipe section 228 extending in the same direction as the drinking tray 400. The water outlet port 204 of the water outlet pipeline 202 is arranged at the end of the horizontal pipe section 228. During use, the water outlet 204 of the water outlet conduit 202 just contacts the water surface 1 of the drinking tray 400, which can reduce the noise generated by the water flow when the water is discharged.

Referring to FIGS. 19-20, in some embodiments, a plurality of legs 114 are provided below the water tank assembly 100. In some embodiments, corresponding to the cuboid shape of the tank body 101, four legs 114 are provided, which are respectively positioned at the corners of the tank body 101. A protection pad 110 (e.g., silicone or other suitable material) can be disposed on a lower surface of each of the legs 114. As shown in FIG. 7, a plurality of recesses 316 are provided on an upper surface the base 300 at corresponding positions relative to the legs 114 and are configured for each recess 316 to receive a corresponding leg 114. When the tank body 101 is mounted on the base 300, the sidewall of the tank body 101 is flush with the sidewall of the base 300. In the illustrated embodiment, there is no additional connecting means between the base 300 and the water tank assembly 100, so the tank assembly 100 can be easily removed from the base 300. The matching design of the legs 114 and the recesses 316 can also prevent the water storage tank 100 from being knocked over by pets during use, causing water leakage.

The pet water dispenser 10 is provided with one or more water cleaning means (e.g., filtering, sterilization, etc.). In some embodiments, the pet water dispenser 10 is provided with at least two water cleaning means. Referring to FIGS. 6 and 8, the water pumping assembly 200 can include an ultraviolet lamp 224. Any suitable ultraviolet lamp 224 can be used. The ultraviolet lamp 224 can be positioned on the water pumping assembly 200 to direct ultraviolet light onto the water in the interior space 102. For example, the ultraviolet lamp 224 can be mounted on, adjacent, or proximate the extension portion 226, which extends into the interior space 102 through the communication opening 402 formed on the drinking tray 400. The ultraviolet lamp 224 can include a casing and an incident end surface 248 disposed in the casing. The incident end surface 248 is provided with ultraviolet lamp bulbs or beads. The incident end surface 248 is inclined towards the interior space 102, so that the irradiation range of the ultraviolet lamp 224 covers, the majority of, most of, or the entire the interior space 102.

In some embodiments, the filter assembly 500 can be provided in conjunction with another means for cleaning the water (e.g., the ultraviolet lamp 224) or as a sole means for cleaning the water. In some embodiments, the filter assembly 500 is provided in the water tank assembly 100 for purifying and filtering water flowing back into the interior space 102 from the drinking tray 400. In some embodiments, a cleaning means (e.g., filter, UV lamp, or other sterilizing or filtering device, etc.) can be associate with the water inlet port 207 of the water inlet conduit 206. The cleaning means associated with the water inlet port 207 of the water inlet conduit 206 can be incorporated in the pet water dispenser 10 in conjunction with other cleaning means, such as the ultraviolet lamp 224 and/or the filter assembly 500. In some embodiments, the cleaning means associated with the water inlet port 207 of the water inlet conduit 206 includes a water filter 252 arranged at the water inlet port 207 such that water from the interior space 102 being drawn into the water inlet conduit 206 flows through the water filter 252. In some embodiments, the filter assembly 500 is replaceable and detachably arranged on the drinking tray 400.

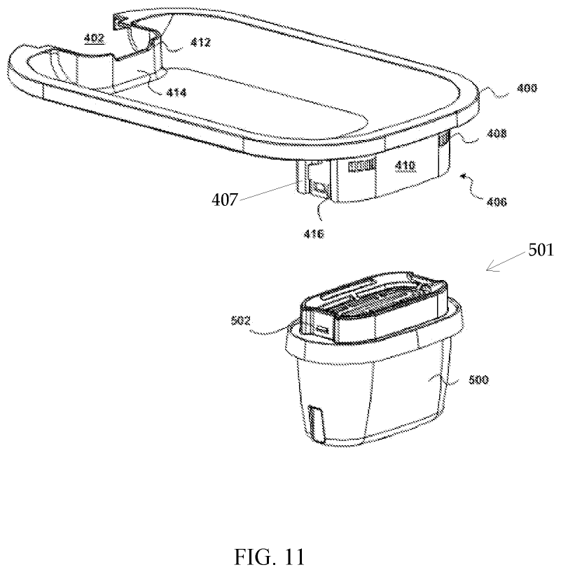

In some embodiments, as shown in FIGS. 11-12, the drinking tray 400 has a generally flat shape with a recessed upper surface having a certain water storage capacity such that pets can drink from the water in the drinking tray 400. As mentioned above, a first end of the drinking tray 400 defines the communication port 402. A second end of the drinking tray 400, opposite the communication port 402, forms a water return port 404. In some embodiments, the water return port 404 is lower, or partially lower, than the water outlet 204 of the water outlet conduit 202. In some embodiments, to reduce the noise associate with adding water to the water in the drinking tray 400, the water return port 404 is configured such that the horizontal pipe section 228 of the water outlet conduit 202 and the water outlet 204 are slightly higher than the water surface 1, or that the bottom of the horizontal pipe section 228 touches the water surface 1.

In some embodiments, the filter assembly or element 500 is disposed below the water return port 404. As shown in FIG. 11, the drinking tray 400 has a filter connecting portion 406 extending downward (i.e., toward the interior space 102) below the water return port 404. The filter connecting portion 406 is used for detachably and fixedly connecting the filter assembly 500 to the drinking tray 400. The filter assembly 500 can include any suitable filtering material. In some embodiments, the filter assembly 500 is an activated carbon filter element.

The filter assembly 500 can be configured in a variety of ways. In the illustrated embodiment, the filter assembly 500 has a water inlet portion 501 configured in a cross-sectional shape of an oval or oblong. In other embodiments, however, the water inlet portion 501 can be any suitable shape. The filter connection part 406 is configured to have a complementary shape to the water inlet portion 501. In some embodiments, the filter connection part 406 has a pair of sidewalls 407 and an end wall 410 between the side walls 407. In some embodiments, each of the side walls 407 of the filter connection part 406 includes a clamping hole 416. The clamping hole 416 can cooperate with the connector 502 (e.g., buckle, snap, tab, detent, etc.) of the water inlet portion 501 of the filter assembly 500 to detachably connect the filter assembly 500 to the drinking tray 400. In some embodiments, a water inlet portion 501 of the filter element 500 is configured to be received into the filter connection part 40, so that the water inlet portion 501 is positioned just below the water return port 404. In some embodiments, the cross-sectional area of the water inlet portion 501 of the filter element 500 is much larger than the cross-sectional area of the return water port 404. Thus, water flowing through the return water port 404 will enter the water inlet portion 501 of the filter element 500 to fully filter water returning to the interior space 102.

The drinking tray 400 can include one or more overflow ports to prevent water from leaking from the drinking tray 400. In some embodiments, the end wall 410 of the filter connection part 406 is provided with a plurality of overflow ports 408. The overflow ports 408 can be configured in a variety of ways, such as a small opening or hole. In the illustrated embodiment, a plurality of overflow ports 408 are evenly distributed on both sides of the end wall 410 of the filter connection part 406. For example, as shown in FIG. 11, four overflow ports 408 are positioned on each side sides of the end wall 410.

In some embodiments, the drinking tray 400 includes one or more overflow recesses 412. The one or more overflow recesses 412 can be configured in a variety of ways. In the illustrated embodiment, the second overflow port 412 is configured as an opening on an end wall 414 of the communication port 402. After the water pumping assembly 200 is installed, the second overflow port 412 is jointly surrounded by the extension portion 226 of the housing 210 of the water pumping assembly 200 and end wall 414. In some embodiments, the second overflow port 412 is set higher than the overflow port 408 to provide anti-overflow function at different water levels.

In some embodiments, the water pump 208 is installed in the housing 210 and is respectively connected with the water inlet conduit 206 and the water outlet conduit 202 extending out of the housing 210. In some embodiments, as shown in FIG. 9, the water inlet and the water outlet 239 of the water pump 208 are arranged on an upper end of the water pump 208 and are respectively connected to the water inlet conduit 206 and the water outlet conduit 202 through the conduit connector 240. The conduit connector 240 can be configured in a variety of ways. In the illustrated embodiment, the conduit connector 240 is branched into at least four openings which can have different distances to keep the water outlet conduit 202 and the water inlet conduit 206 in ideal usage positions.

In some embodiments, the water pump 208 can be activated and deactivated (i.e., water flow started and stopped) by induction control. For example, an inductive sensor 218 can be disposed on the housing 210 of the water pumping assembly 200. The inductive sensor 218 can be configured to generate a pet detection signal when a pet is detected within a set range nearby. The inductive sensor 218 can be any suitable inductive sensor, such as for example, an infrared sensor, a radar sensor, or other suitable inductive sensors. The inductive sensor 218 is a mature technology in the prior art, and its principle will not be described here. In some embodiments, the induction sensor 218 is disposed above the water outlet conduit 202 on the front of the housing 210 of the water pumping assembly 200.

In some embodiments, the water pumping assembly 200 is also provided with controller, such as a main control chip. The controller can be configured to receive the pet detection signal generated by the induction sensor 218 and generate a driving signal to drive the water pump 208 to act. The controller can be any suitable controller, such as for example, a single-chip microcomputer chip or other MCU chips. In some embodiments, the controller has multiple input/output interfaces, such as for example, serial communication interfaces, connected to the inductive sensor 218 and the water pump 208. The controller can also have a communication interface. In some embodiments, the communication interface can support different wireless communication protocols, such as WiFi, Bluetooth communication, near-field communication, etc. Thus, the controller can communicate with other electronic devices to output the working status of the pet water dispenser 10. For example, the working status can be displayed through different interfaces associated with the water dispenser 10.

In some embodiments, the controller can be a main control chip integrated on a first main board 216 (FIG. 9). In some embodiments, first main board 216 can be integrated with a power management chip, a voltage stabilizing chip, and the like. The first main board 216 can be fixed on a first main board bracket 242 to keep the first main board 216 stable and working correctly.

In some embodiments, the housing 210 of the water pumping assembly 200 further includes an upper cover 232 and a sealing ring 234 that is provided between the upper cover 232 and the housing 210 to improve the watertight performance of the water pumping assembly 200. A switch button 236 or other suitable actuator, can be associated with the water dispenser 10. In some embodiments, the switch button 236 is disposed on the upper cover 232. In some embodiments, the switch button 236 can be a mechanical button (FIG. 9). In other embodiments, however, the switch button 236 can be a membrane button, a touch button, or other suitable actuator. In some embodiments, an indicator light 238 is arranged around the switch button 236.

In some embodiments, the water pumping assembly 200 can include a first battery 222 that is used to supply power to the water pumping assembly 200 (e.g., to supply power to the water pump 208, the controller, and the induction sensor 218). In some embodiments, the first battery 222 can also provide power to the base 300. In some embodiments, the first battery 222 can be a rechargeable battery and the water pumping assembly 200 can include a first charging interface 250 is provided on the housing 210. In some embodiments, a waterproof silicone plug 244 is provided for the first charging interface 250. In some embodiments, the water pumping assembly 200 can be charged independently from the base 300.

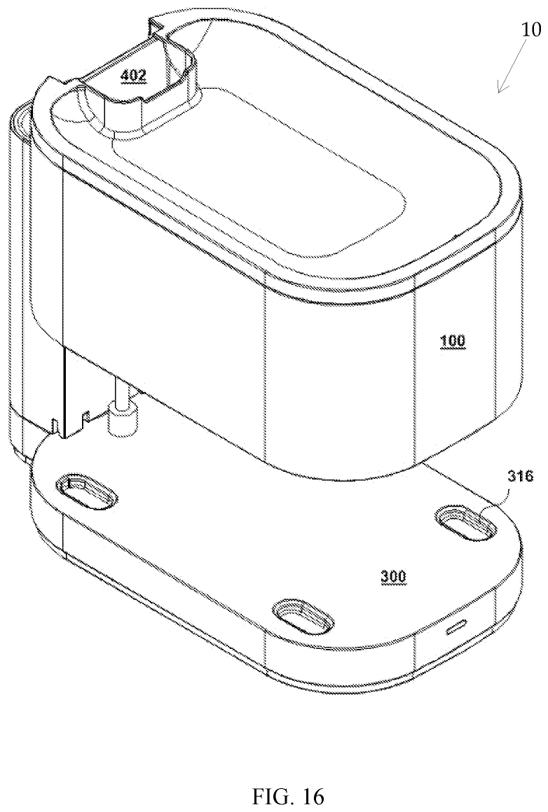

As shown in FIGS. 16-18, in some embodiments, the water pumping assembly 200 and the base 300 are communicatively connected. One of the water pumping assembly 200 and the base 300 can be provided with a terminal and the other with a communication interface. The terminals and interface can be configured in a variety of ways. For example, in some embodiments, a pogo pin 220 is provided at a lower end of the housing 210 of the water pumping assembly 200. The communication interface 320 matching the pogo pin 220 can be provided at a corresponding position on the base 300. The terminal 220 and the interface 320 can be placed in contact with each other to establish a communication connection. In some embodiments, the terminal 220 is fixed by the terminal cover 246.

With the water pumping assembly 200 and the base 300 communicatively connected, the controller can receive the weighing detection signal generated by the load cell 302 and output the water volume information through the communication interface 320 and displayed through different interfaces associated with the water dispenser 10. For example, in some embodiments the interfaces associated with one or more electronic devices communicatively connected to the controller. In some embodiments, an interface may also be provided on the water dispenser 10, such as for example, at the lower end of the housing 210 of the water pumping assembly 200.

Referring to FIGS. 13-15, in some embodiments, the base 300 can includes a tray 310 and a chassis 312. The tray 310 and the chassis 312 can be connected by fasteners (e.g., bolts). In some embodiments, an interface holder 318 is integrated on the tray 310. In the illustrated embodiment, the base 300 includes four load cells 302. In other embodiments, more or less than four load cells 302 may be used. The four load cells 302 are respectively arranged at four corners of the chassis 312 to accurately measure the total weight of the water tank assembly 100 and the drinking tray 400. In the illustrated embodiment, the load cells 302 are respectively fixed by brackets 308 that are received in respective installation recesses 321 formed in the base 300. In some embodiments, the bottom of the base 300 can include silicone protection pads 324, which increases friction and make the water dispenser 10 more stable during use while also protecting the chassis 312 from wear and tear.

In some embodiments, the base 300 includes a second battery 304 that supplies power to the base 300 (e.g., supply power to the load cells 302). In some embodiments, the second battery 304 is rechargeable. In some embodiments, the base 300 can be charged independent from the water pumping assembly 200. For example, a second charging interface 328 can be provided on the base 300. In some embodiments, a charging interface waterproof plug 322 is provided at the second charging interface 328. The charging interface waterproof plug 322 can be made of any suitable material, such as for example, silica gel. In some embodiments, the base 300 is further provided with a second main board 306 and a power chip 314 is integrated on the second main board 306 to realize charging and discharging of the second battery 304.

In some embodiments, one of the first battery 222 and the second battery 304 can provide power for the water pumping assembly 200 and the chassis 300 at the same time. For example, of the first battery 222 and the second battery 304, the battery with the higher voltage can be used. In some embodiments, both batteries can supply power to the water pumping assembly 200 and the chassis 300 at the same time. The configuration of dual batteries can prolong the use time of a single charge of the water dispenser 10.

In some embodiments, the base 300 is provided with a WIFI indicator light 326. A touch button or other actuator can be selectively set at the WIFI indicator light 326 for resetting the distribution network. The WIFI indicator 326 can choose one to display the distribution network status or the battery power. For example, in some embodiments, a white light can indicate the distribution network status. A constant white light indicates that the network distribution is successful while a blinking white light indicates that the network distribution is not successful. Similarly, a green light can indicate battery power. A constant green light indicates that the battery power is sufficient while a blinking green light indicates that the battery is charging.

While the inventive concepts of the present application have been illustrated by the description of embodiments thereof, it is not the intention of the applicant to restrict or in any way limit the scope of the appended claims to such detail. Therefore, the invention, in its broader aspects, is not limited to the specific details, the representative apparatus, and illustrative examples shown and described. Accordingly, departures can be made from such details without departing from the spirit or scope of the general inventive concepts.

1. A pet water dispenser, comprising:
a water tank assembly comprising:
a tank body defining an interior space for storing water; and
a top cover detachably arranged on the tank body above the interior space, the top cover having an upper surface that at least partially defines a drinking tray with a first water return port;
a filter assembly detachably installed in the interior space and located below the first water return port; and
a water pumping assembly detachably connected on a side of the tank body, the water pumping assembly configured to circulate the water from the interior space into the drinking tray where the water can return back into the interior space through the first water return port and the filter assembly.

2. The pet water dispenser of claim 1, wherein upper surface forms a concave shape having a bottom surface, and wherein the first water return port is positioned higher than the bottom surface.

3. The pet water dispenser of claim 2, wherein the first water return port is located on a curved surface.

4. The pet water dispenser of claim 1, wherein the water pumping assembly is received in a recessed portion of an outer surface of a sidewall of the tank body.

5. The pet water dispenser of claim 1, further comprising a second water return port located below the filter assembly, wherein the water filtered by the filter assembly returns to the interior space via the second water return port.

6. The pet water dispenser of claim 1, wherein the top cover comprises a downward projecting edge the fits over a top edge of the tank body.

7. The pet water dispenser of claim 1, wherein the filter assembly includes a filter housing defining a filter cavity configured to house a replaceable filtering element.

8. The pet water dispenser of claim 7, wherein a bottom surface of the drinking tray comprises a guide wall arranged around the first water return port, the filter housing is configured to pluggably insert into the guide wall.

9. The pet water dispenser of claim 8, wherein the guide wall comprises a guide rib, the filter housing is configured to pluggably insert into the guide wall.

10. The pet water dispenser of claim 8, wherein the guide wall comprises a clamping hole that cooperates with the filter assembly to detachably connect.

11. The pet water dispenser of claim 8, wherein the drinking tray comprises a first tray body and a second tray body, the first water return port is provided on the second disc body.

12. The pet water dispenser of claim 11, wherein the first tray body and the second tray body are configured to be water sealed after assembled together.

13. The pet water dispenser of claim 7, wherein the filter cavity is in fluid communication with the first water return port.

14. A pet water dispenser, comprising:
a water tank assembly comprising:
a tank body defining an inner cavity for water storage; and
a top cover detachably arranged on the tank body above the inner cavity, the top cover having an upper surface that at least partially defines a drinking tray with a first water return port;
a water pumping assembly detachably arranged on a side of the tank body, the water pumping assembly configured to circulate the water from the inner cavity into the drinking tray; and
a base onto which the tank body is detachably arranged, the base having one or more load cells communicatively connected to the water pumping assembly.

15. The pet water dispenser of claim 14, further comprising a controller, the controller configured to receive a signal from the one or more load cells indicative of a water volume in the inner cavity and the drinking tray and to output water volume information to a user interface based on the signal.

16. The pet water dispenser of claim 15, wherein the controller is a control chip positioned in the water pumping assembly.

17. The pet water dispenser of claim 14, wherein the water pumping assembly includes a first rechargeable battery and the base includes a second rechargeable battery, wherein the first rechargeable battery and the second rechargeable battery can be charged independent of each other.

18. The pet water dispenser of claim 14, wherein the base includes a plurality of recesses, and the tank body includes a plurality of supporting legs, wherein each of the plurality of recesses is configured to receive a corresponding one of the plurality of supporting legs.

19. A pet water dispenser, comprising:
a water tank assembly comprising:
a tank body defining an interior space for storing water; and
a top cover detachably arranged on the tank body above the interior space, the top cover having an upper surface defining a drinking tray with a first water return port;
a filter element detachably connected to the top cover;
a water pumping assembly detachably connected on a side of the tank body, the water pumping assembly configured to transport the water from the interior space to the drinking tray;
the water pumping assembly comprising:
a housing detachably connected with the tank body;
a pump arranged in the housing;
a sensor is arranged on the housing and configured to generate a pet detection signal;
a controller arranged in the housing, the controller communicatively connected with the sensor and the pump, wherein the controller is configured to receive the pet detection signal from the sensor and, based on the pet detection signal, control the pump to send the water to the drinking tray or stop sending the water to the drinking tray.

20. The pet water dispenser of claim 19, wherein the pump includes a water inlet connected to a water supply conduit that extends into the interior space and a water outlet connected to a water outlet conduit configured to deposit the water into the drinking tray.

21. The pet water dispenser of claim 20, wherein the water outlet conduit is L-shaped and includes a horizontal pipe section configured to position a water outlet port of the water outlet conduit at a surface of the water in the drinking tray.

22. The pet water dispenser of claim 19, wherein the first water return port is located at an opposite side of the drinking tray from the water pumping assembly, and wherein the first water return port is at least partially lower than the water outlet of the water outlet conduit.

23. The pet water dispenser of claim 19, wherein the top cover is provided with a communication port, at least a port of the water pumping assembly is configured to insert into the internal space through the communication port.

24. The pet water dispenser of claim 23, wherein the tank body further comprises:
a first connecting part, disposed on a side wall of the tank body near the communication port and recessed toward the communication port;
a second connecting part, disposed at a bottom of the side wall;
wherein the water pump assembly further comprises:
a first mounting slot and a second mounting slot, disposed on the housing,
wherein the first connecting part is configured to insert into the first mounting slot, and the second connecting part is configured to insert into the second mounting slot so that the pump assembly is able to connect to the tank body.

25. The pet water dispenser of claim 23, wherein the communication port is at least partially defined by an end wall extending upward from the upper surface of the top cover, and the end wall comprises an overflow recess that is higher than the first water return port and is lower than an upper edge of the top cover.

26. The pet water dispenser of claim 19, further comprising a filter element connector that detachably connects the filter element to the drinking tray, the filter element connector positioned below the first water return port.

27. The pet water dispenser of claim 19, wherein the water pumping assembly includes an ultraviolet lamp positioned within the interior space, the ultraviolet lamp having an incident end surface provided with lamp beads wherein the incident end surface is arranged obliquely towards the interior space.
